(19) United States
(12) Patent Application Publication
(10) Pub. No.: US 2019/0291139 A1
(43) Pub. Date: Sep. 26, 2019

(54) Secondary Separation System for Processing and Tracking Recyclables and Non- Recyclables

(71) Applicant: Michael C Centers, Danville, CA (US)

(72) Inventor: Michael C Centers, Danville, CA (US)

(21) Appl. No.: 15/936,167

(22) Filed: Mar. 26, 2018

(51) Int. Cl. B07B 9/02; B07B 4/02; B03B 9/06; B07B 1/46; B07B 9/00; B07B 1/28

(52) U.S. Cl. CPC B07B 9/02; Y10S 209/93; Y02W 30/525; B07B 4/02; B03B 9/061; B07B 1/28; Y02W 30/523; B07B 9/00; B07B 1/46

(57) ABSTRACT

The present invention discloses apparatus and methods for separating waste residual from a Materials Recovery Facility into multiple recyclable and currently conventionally classified as non-recyclable fractions; accounting for the weight distribution of each fraction and reporting such data to stakeholders.

### CROSS REFERENCED TO RELATED APPLICATIONS

U.S. Pat. Nos. 7,188,730 and 8,813,972 are incorporated herein in their entirety by reference.

### BACKGROUND OF THE INVENTION

### Field of Invention

The present invention discloses apparatus and methods for separating waste residual from a Materials Recovery Facility into multiple recyclable and currently conventionally classified as non-recyclable fractions; accounting for the weight distribution of each fraction and reporting such data to stakeholders.

For purposes of this application a generalized overview of the Municipal Solid Waste, MSW, collection and trash processing steps as practiced in the U. S is given. A materials recovery facility, materials reclamation facility, materials recycling facility or Multi re-use facility, all designated MRF, is a specialized plant that collects, separates and prepares Municipal Solid Waste, MSW, materials for one of three options, recycling, composting or land fill. In the process the MRF creates its own waste stream, termed “yield loss” or residuals or waste residual, may be more than 15% by weight of the material the MRF takes in. In 2017 the National Waste & Recycling Association, NWRA, named FCC Environmental Services' MRF located in Dallas, Tex. the best recycling facility in the U.S. In 2015 FCC signed a contract with the city of Dallas to achieve the following goals for waste diversion, comprising recycling and waste to energy, from 40% by 2020 and up to 80%, termed “zero waste”, by 2040. The residual not diverted must be landfilled. Eliminating the landfill problem is the primary focus of the instant invention.

Trash collection in environmentally conscious cities in the United States has evolved into a three-bin system. One bin for Composting, defined as anything that has been grown, including paper, food waste and cotton or wood and yard trimmings. One bin for landfill, defined as non-recyclables, and one bin for recyclables. The instant invention discloses apparatus and methods for separating waste residual from a MRF into multiple recyclable and currently conventionally classified as non-recyclable fractions; accounting for the weight distribution of each fraction and reporting such data to stakeholders. For purposes of the instant invention the current definition of one municipality, Palo Alto, Calif., for setting the current practice of compost, recycle and non-recycle, thus landfill, is used. FIGS. 1A, B and C describe the three categories of waste as designated by Palo Alto. Each home and business has three trash bins allocated for trash pickup. What is disclosed herein is a process for recovering all of the currently designated “landfill” material plus all of the waste residual generated by a MRF that processes the recycle category; waste residual is material the primary MRF chooses not to process based for a variety of factors, mostly economic plus the material designated for landfill. Frequently the recycle trash bin is blue in color and frequently referred to as the blue bin. As noted in FIG. 1A recycle items comprise plastics, #1-7 and film, paper, glass, metal, ferrous and non-ferrous, and e-waste, being small appliances. FIG. 1B notes compost waste comprising food scraps, soiled paper, compostable plastic and yard trimmings; specifically cartons and pizza boxes are included in compost versus recycle. FIG. 1C shows landfill items comprising multi-material containers, “garbage” comprising pet waste, Styrofoam containers, pottery and random plastics. A key measure of the municipalities is achieving “zero waste” wherein material going to a landfill has been reduced dramatically if not to zero. An important aspect of the instant invention is accounting for where material ends up and using that feedback to continue progress toward “zero waste” and zero landfill diversion by improving packaging practices to conform to recycle needs. More importantly material diverted from landfill is closing the loop on products known in the industry as cradle to grave accountability. FIG. 2 is a schematic example of the desired goal of “zero waste”; in this example all processed material goes either to a “Material Recycler” or a “waste-to-energy” operation. FIG. 3 is data from the EPA in 2014 found in HISER, JENNIFER M.; “All a diversion?”; June 2016; M.I.T.; Master in City Planning, incorporated herein in its entirety by reference, showing average disposal and recovery per capita in the U.S. by diversion type; landfill is tallied at about 900 pounds per day in 2010 or over 50% of the disposal rate of 1600 pounds per day per capita.

The present invention discloses a system to collect, sort, and account for a portion of material placed in a customer recycle bin via a single stream curbside collection program for residents and commercial facilities. This invention extends U.S. Pat. No. 8,813,972 and discloses novel methods for processing and tracking recyclables and items currently not considered to be recyclable. The term “non-recyclable” is a moving target based upon the location, local customs and cost of “recycling” various items versus cost of land filling those items. The method disclosed herein relies on a relationship between one or more primary MRFs, serving a community or region, and a “secondary MRF™” that accepts residual waste streams rejected by the primary MRF. The goal of all municipalities in the U.S. is to approach “zero waste”; Palo Alto notes this in FIG. 1A; however no city in the U.S. has met the goal as the current cost of achieving zero waste is prohibitive. The goal of the instant invention is to enable a “secondary MRF™” to accept all items not recycled or composted by primary MRFs; the secondary MRF then separates these items into multiple groupings, each having commercial value, such that the items being landfilled are minimized or, in fact, reduced to zero.

Herein are disclosed techniques and methods, implemented by a “secondary MRF™” comprising a novel data collection system beneficial to brand owners and municipal administrators seeking to improve recycling performance. U.S. Pat. No. 8,813,972 outlines the design of a “secondary MRF™” and how a “secondary MRF™” targets and separates refuse material-by-material or group-by-group. Currently the material not recycled by a primary MRF is dependent on several factors which may have nothing to do with an item's material content. The MRFs installed equipment for separating waste streams by content and size are determining factors given the manner in which the local waste stream is collected; three segregation bins are obviously a first step in trash separation; single bin collection virtually prevents trash separation based solely on cost.

### BRIEF SUMMARY OF THE INVENTION

U.S. Pat. No. 7,188,73 and U.S. Pat. No. 8,813,972 disclose processing steps to categorize and sort by size and material type materials rejected by a primary MRF. The size targeted is any material from 14 inch to 6 inches; should the material be discarded paper or film the size may be up to 16 inches. The type of material, termed waste residual, is all the material the primary MRF chooses not to sort by material type plus material the MRF may have designated for landfill.

Currently, as noted in U.S. Pat. No. 8,813,972, the Big 7 are identified as cardboard and paper, mixed waste paper, glass, aluminum, PET, HDPE and tin. When a the primary MRF sends material outside the Big 7 that they cannot economically sort by material type to a secondary MRF™; the Secondary MRF will sort the stream, removing all valuable materials, identifying what materials are still going to landfill and generate a report on recovery for that entire recycle bin base. This report gives a city an ongoing report card on what is being recycled that is placed in the recycle bin and more important what is not. In addition, given that the secondary MRF is local, all material not recycled by material type is sent to a responsible end use and disposed responsibly; this step eliminates the risk of pollution via third world exports of mixed plastics. As the secondary MRF opens markets for every items sorted the cities can continue to shift material from the landfill or black bin to the recycle bin improving overall diversion and adding valuable resources to the economy.

In some embodiments a secondary MRF, on a quarterly basis, defines brands by material type and generates a report on the cost to recycle either by brand or by material type. A secondary MRF™ reports these numbers for the households and/or commercial recycle bin customers represented by primary MRFs. These reports are also available for purchase by interested brand owners who have a stake in having their package recycled. These reports help steer the entire recycle bin collection and sorting system as innovative packages are developed and used in the future.

As noted the primary MRF is sorting by material type into the Big 7 to maximize its recycle value. Given the diverse size and type of material placed in the recycle bin significant cross contamination exists. For example, a primary MRF produces a bale of mixed waste paper with significant cross “contamination”, including water bottles, plastics and film, trash, light aluminum etc. The instant invention provides a method to improve the value of the recycle product by reducing “contamination”.

### BRIEF DESCRIPTION OF THE DRAWINGS

FIGS. 1A, B and C are examples of waste separation by Palo Alto, Calif. residents.

FIG. 2 is a schematic of a “Zero Waste” enablement.

FIG. 3 shows the “Average Disposal and Recovery Per Capita in the U.S. from 1960 to 2010

FIG. 4 is a flow diagram disclosed in U.S. Pat. No. 8,813,972.

FIG. 5 is a flow diagram of one embodiment of the instant invention.

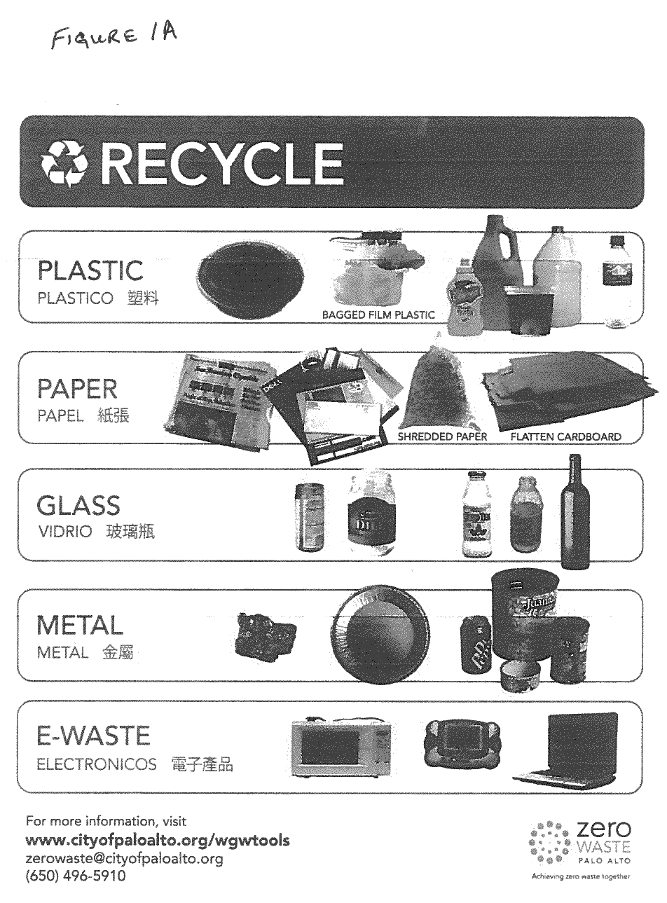

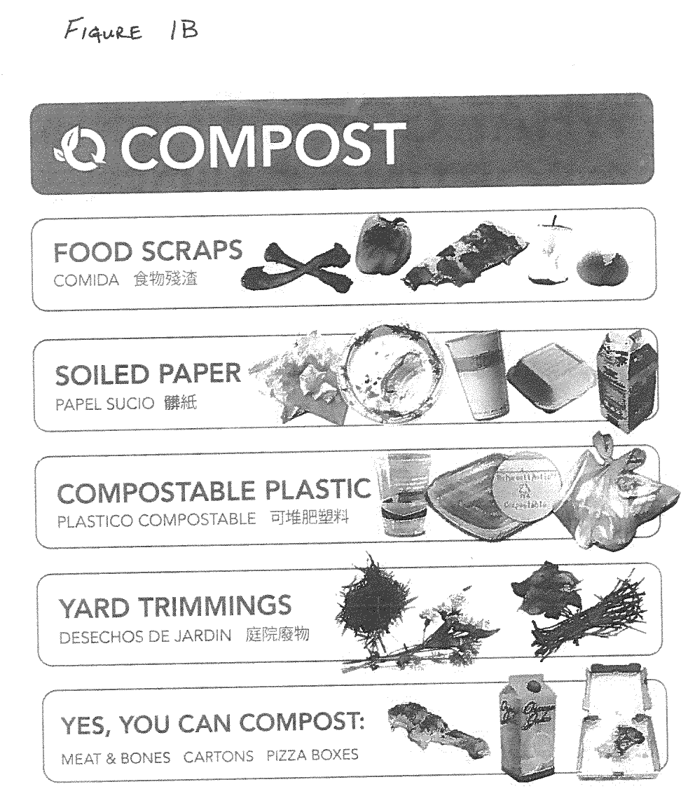

### DETAILED DESCRIPTION OF THE INVENTION

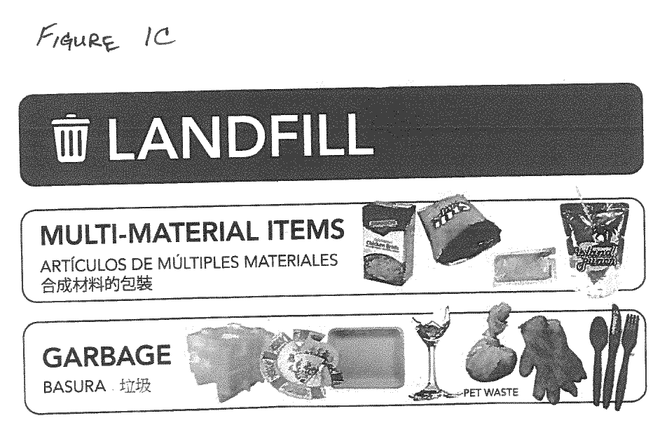

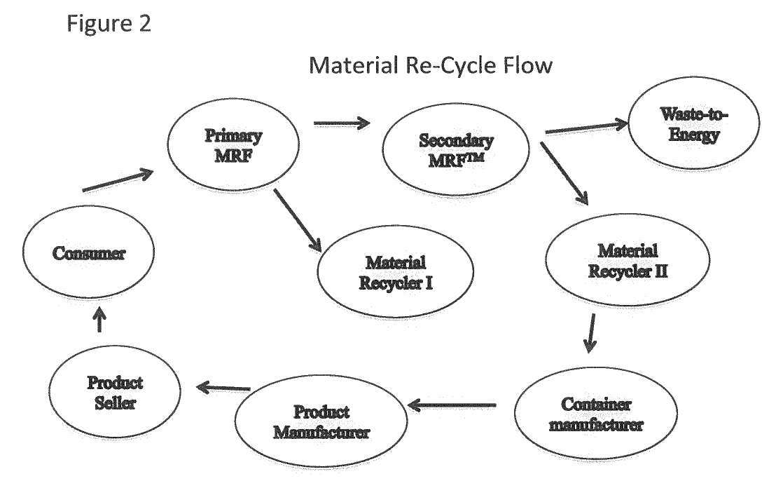

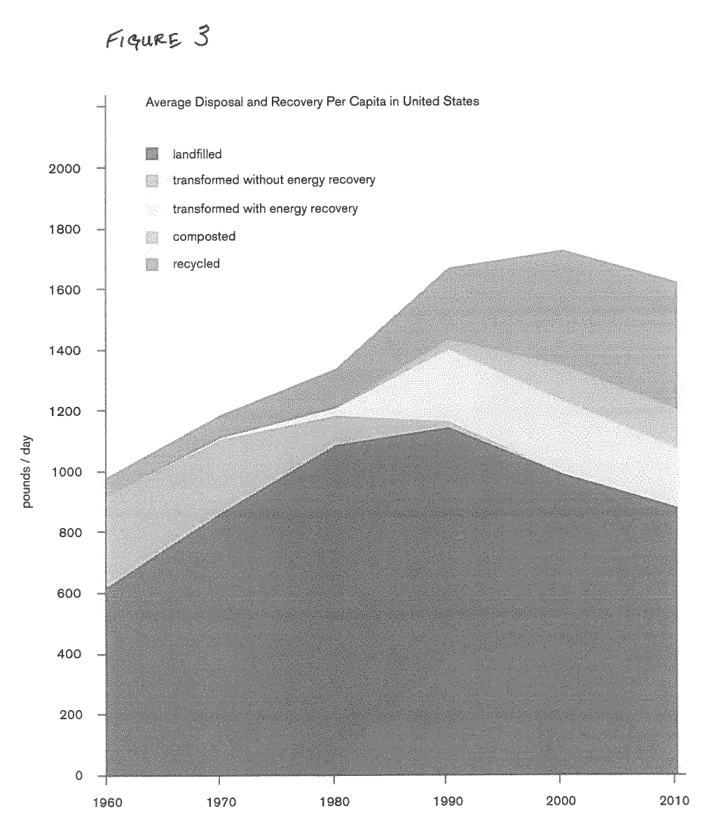

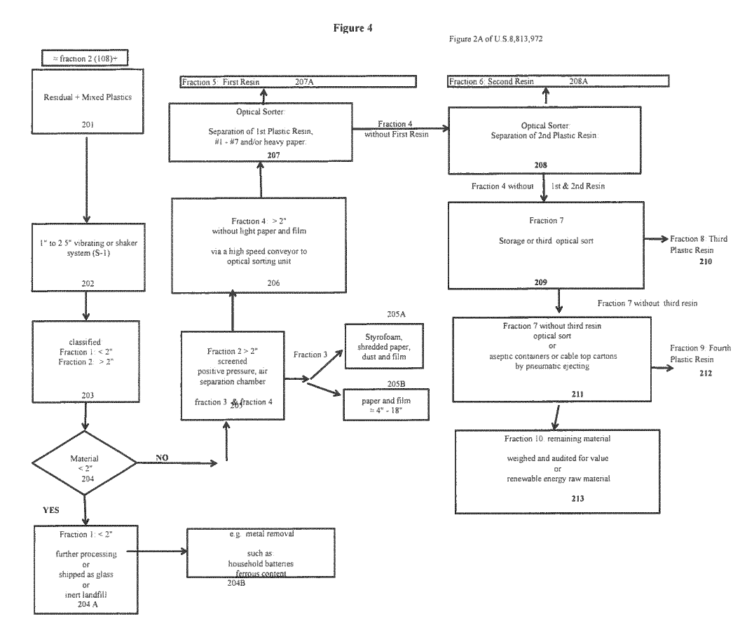

FIG. 2A from U.S. Pat. No. 8,813,972 is presented as FIG. 4 and described again for clarity. A distinction between the instant invention and U.S. Pat. No. 8,813,972 is that now material entering the “secondary MRF”™ process, designated element 201, comprises the MRF designated residual waste and the MRF's designated landfill material. A primary MRF's residual waste stream is defined as all material a primary MRF's chooses not to separate for reclaim either because of material type or material size, such as too small or too big or other reasons primarily economic. A residual waste stream may also be referred to as machine yield loss or mixed plastics, or mixed waste paper or mixed film or mixed rigids; “film” in this context is any thin, flexible plastic sheet, such as grocery bags or food wrapper; rigids in this context are home depot buckets, plastic lunch trays, plastic toys or chairs. The economics of recovery of residual waste streams is not favorable for a primary MRF which is the reason for a primary MRF to not sort them; the result is that this material is landfilled if no “secondary MRF” ™ is available. In some cases a residual waste stream is material from a pre-sort area where it is diverted before the primary MRF starts its mechanical sorting; typical items removed are film, mixed rigids, large format plastics, and e-waste. These items are primarily pulled from the first sorting station at a primary MRF and placed into large bunkers or roll off boxes to be baled and shipped out for further processing. In general a primary MRF sorts all material of choice and diverts the balance to a “secondary MRF”™. The goals of a primary MRF and a “secondary MRF”™ are to send all material to a reclaim operation, compost operation or waste-to-fuel operation, eliminating the need for landfill. As disclosed herein a “secondary MRF”™ operation performs an accounting of all material received from the various primary MRFs in a geographical region; sorts received material such that economic value is maximized; characterizes the material by type and by supplier; allocates the remainder to be sent to a waste-to-fuel operation and notifies a regional authority on needs for package improvements. An innovation of the instant invention is identification of all the material primary MRFs have chosen not to sort such that items previously designated for landfill can be reduced to zero. By generating a communications report to a regional authority for what is not recycled a closed loop report on the progress to “zero waste” can be generated. Table 1 shows the various plastic type and the number stamped on most plastic parts for identification.

TABLE

| | |
|---|---|
| Number 1 Plastics: | PET or PETE (polyethylene terephthalate) |
| Number 2 Plastics | HDPE (high density polyethylene) |
| Number 3 Plastics | V (Vinyl) or PVC |
| Number 4 Plastics | LDPE (low density polyethylene) |
| Number 5 Plastics | PP (polypropylene) |
| Number 6 Plastics | PS (polystyrene) |
| Number 7 Plastics | Other, including polyactide, polycarbonate, PLA, |
| | PETG, multi-layer packages |

FIG. 4 shows a schematic embodiment of a “secondary MRF”™ apparatus from U.S. Pat. No. 8,813,972. A residual waste stream enters a “secondary MRF”™ apparatus at 201, typically a 48 to 72 inch wide conveyer. 202 and 203 perform a first separation into Fraction 1, less than about 2 inches, and Fraction 2, greater than about 2 inches; 2 inches refers to the smallest dimension of an object being processed. Fraction 1 is processed further for glass, plastic and/or metal removal as shown in 204A and 204B and 204C. Fraction 2 proceeds to a first pneumatic air separator, 205. Fraction 3, separated out at this step, comprises Styrofoam, shredded paper, dust, light film, all designated 205A, and heavier paper and heavier film, designated 205B. FIG. 2B shows that the heavier fraction, 205B may be captured in a drop box; the lighter fraction, 205A, may be captured in a cyclone. Fraction 4, substantially free of materials comprising 205A and 205B, proceeds to a next step. In some embodiments a next step is a repetition of step 205, not shown, with different velocity air flows, both positive and negative, wherein two additional types of material are removed from the input stream 201. The two additional types of material may comprise plastic bottles or even heavier paper or cardboard, as noted in 207. Plastic bottles, empty or not, may be separated out; items up to and including 5 gal. buckets may be separated out using a variable air flow pneumatic separator comprising an upward flow source below a screen and a upward flow source above the screen; both sources independently controlled in their air flow velocities; the upward flow source above the screen comprises a drop box for the relatively heavier items and a cyclone for capturing the relatively lighter items.

Adjustment of air flow velocity may be accomplished by a variable speed drive (VSD) modulating the frequency, Hertz, for each blower motor. An operator may adjust the system using VSD to optimize the number or type of light materials removed via “negative air”, the upward flow source above the screen. This is an important aspect of the invention; an operator may desire to remove light plastics such as 6 oz. bottles through the air system versus through the optical sorter to not only reduce demand on the optical sorters but also reduce the complexity of the stream into an optical sorter. In some embodiments a VSD has a range for the positive air, below the screen, of 10 Hz to 50 Hz. and a range for “negative air” may be from 25 Hz to 90 Hz. Exemplary pneumatic separators are offered by Twin City Fan and Blower Co. In some embodiments a positive air blower, blowing in an upward motion, of size 182 BAF, Arr 9, Class 1 Complete with access door, flanged outlet, inlet screen, belt guard, shaft and bearing guard, V-Belt drive, and a 5 HP, 1800 RPM, 460-3-60 TEFC Motor is used. In some embodiments a “negative” air blower, exhausting in an upward motion, from Twin City Fan and Blower Co. is a size 915 RBW, Arr. 9, Class 22, CW BHD, complete with access door, flanged outlet, inlet screen, belt guards, shaft and bearing guard, V-belt drive and a 40 HP, 460-3-60 TEFC, VDF Motor; rating 9,500 CFM, 15″ SP, 2,036 RPM, 18.72 BHP.

The transition from the vibratory screen to the air separation is accomplished for all materials regardless of size using the art defined by the author in U.S. Pat. No. 7,188,730. The difference is scaling of the transition chute, screens, and blowers. In the original art the material was typically under 2.5 inches in size and the screen width no more than 48 inches in size. In this application the material is less than 12 inches in size and the screen width may be 60 to 72 inches in width. By creating the air chute the same length as the vibratory screen you get flawless separation.

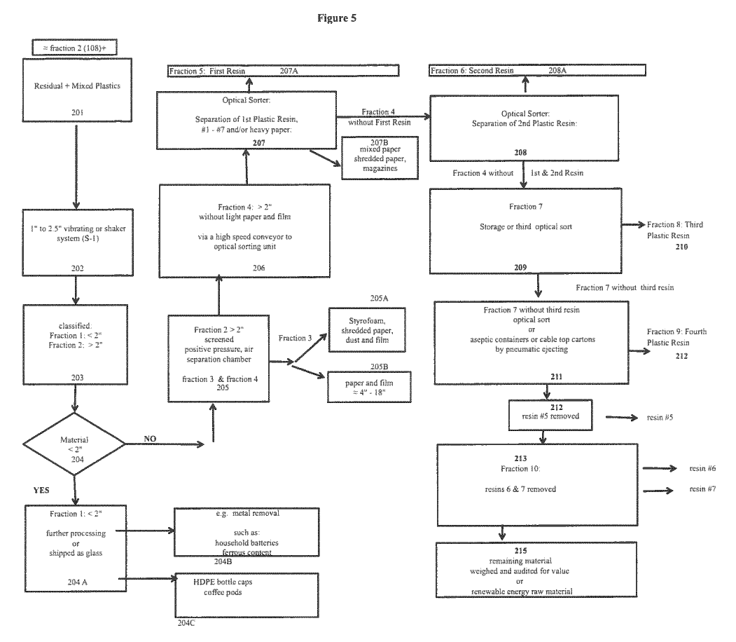

The sequence for sorting material as noted in FIGS. 4 and 5, elements 201 thru 213, is a generalized diagram. In the instant invention under two inch material is separated into material fractions of predetermined compositions. Material is separated in the following sequence: by size, then density, then composition; for example, glass, metal-non-ferrous, batteries, metal-ferrous, paper. In the size category there is small format plastics, such as polypro, PP, bottle caps, HDPE bottle caps, Coffee pods made from one material type (PP or HDPE), pill containers made of polystyrene, PS, HDPE, or PPPS containers. By separating these items from the other under-two-inch material more economic value is created as well as improving the overall quality of the balance of material that is under two inches.

The (secondary MRF's)™ role in the system it to sort the lower volume material that is received from the primary MRF. Packaging materials and types are constantly changing; innovation into new packages can occur without placing an undue burden on the primary MRF's sorting systems.

In FIG. 5 box 201 receives the primary MRF residual waste stream; and sorting as noted in 202, 203, 204, 205, 206 and 207. The 207A fraction is a first resin fraction; based on convenience it may be any of the plastics from #1-#7. An added sort is 207B which is a fiber defined as mixed waste paper including brown, white, and magazines or junk mail. Fraction 207B can be furthered sorted by separating the brown paper from the white paper and removing non-paper using an optical sorter.

The pass thru fraction is fraction 4 and that goes to a machine that separates resin #2 from resin #3. At step 209 resin #3 is separated from fraction 7; resins 1 and 2 and all paper have been removed at steps 207B. At 209 resin #4, fraction 9, is removed and now in 212 resin #5 is removed; alternatively aseptic containers and/or cable top cartons are removed in 211. Now, 213 now removes resins #6 and 7 from fraction 10; Newly added 215 finishes the separating and performs various auditing functions for feedback to the stake holders. One of the resins removed will correspond to plastic #3, PVC; after this plastic is separated out any of the remaining plastics and/or paper types may be sent to a waste-for-fuel operator should that be an optimum end use.

Means for separating and/or sorting materials, including recyclables and non-recyclables and the means for sorting and/or separating recyclables from non-recyclables within a residual waste stream comprise one or more screens of given size opening, one or more air separators with a drop box for sorting lighter items for heavier, manual sorting, visual camera detection systems, optical, as in radiation, camera detection systems, including X-ray, UV, Infrared and near infrared, combined with a robotic or mechanical system to selectively separate what the detection systems categorizes using images, pictures, artificial intelligence, bar codes, tracer elements, scales for weighing, size or other easily measured parameters associated with a given material type. These machines are manufactured by Pellenc SA, Tomra Systems ASA, Redwave Solutions US LLC, Max AI®, AMP Robotics, Alchemy Systems Ltd., Starlinger recoStar.

Means for identifying one or more responsible entities associated with one or more material types of the separated non-recyclables comprise communicating with local and regional officials charged with recycling on a regular basis, such as quarterly or annually; communicating regularly with primary MRFs and package manufactures

Means for aggregating the quantity, material type and responsible entity data comprise computerized logging, optical recognition and weighing systems as integral components of the robotic systems or stand-alone systems aided by manual labor or not. In some embodiments a “predetermined composition” is defined based on a 20 pound test lot and visual inspection on every load from a primary MRF; in addition, every quarter 10 tons per MRF are processed through the Secondary MRF™ system to confirm pricing and what's available for recovery; this information is collected as part of the aggregating quantity, material type and responsible entity data.

In some embodiments A secondary separation and tracking system for processing residual waste streams from one or more primary MRF's comprises a means for separating recyclables from non-recyclables within a residual waste stream; a means for separating the recyclables by one or more parameters such that the separated recyclables have commercial value; a means for separating the non-recyclables by one or more parameters such that at least a portion of the separated non-recyclables have commercial value; a means for identifying one or more responsible entities associated with one or more material types of the separated non-recyclables; and a means for aggregating the quantity, material type and responsible entity data such that the data can be communicated to the responsible entity for purposes of reducing the non-recyclable quantity.

In some embodiments a first fraction of material of predetermined composition derived by processing a residual stream from a primary MRF wherein the residual stream is processed through at least one shaker screen comprising openings greater than 2±1.0 inches in a lateral dimension wherein a second fraction with a dimension less than 2±1.0 inches is removed and the processed residual stream is processed through at least one air separation module operating such that a third fraction comprising material with a apparent density less than 0.1 and a lateral dimension greater than the screen openings is transported up and away from the processed residual stream using at least one negative pressure air separation wherein the processed residual stream is processed through at least one optical sorting system wherein a fourth fraction is removed such that the composition of the first fraction, after removal of the second, third and fourth fractions, is between about 90% and 98% by weight of material chosen from a group consisting of plastics with #'s from 1 through 7, ferrous metal, non-ferrous metal, cardboard and paper, mixed waste paper, glass, aluminum, PET bottles, HDPE bottles and tin. The predetermined composition consists of one or more these materials based on maximizing the economic value of the first fraction. Maximizing the economic value of a fraction sorted from a residual stream from a MRF depends on supply and demand, cost of sorting to a given, predetermined composition, market price of a given, predetermined composition and being able to achieve a minimum quantity to be of interest to a buyer. Predetermined compositions may range from season to season with geographical distributions as well. Additional sub-categories exist with the groups mentioned above; for example, glass may be sorted by color; paper may be sorted by color and density as in news print versus cardboard; plastic #3, PVC, may be segregated from other plastics; paper and plastic may be combined for a waste-to-fuel operator; other exemplary predetermined compositions are known to those knowledgeable in art. In some embodiments a “predetermined composition” is defined based on a 20 pound test sample and visual inspection on every load from a primary MRF; in addition every quarter 10 tons per MRF is processed through the Secondary MRF™ system to confirm pricing and what's available for recovery; this information is collected as part of the aggregating quantity, material type and responsible entity data.

In some embodiments a method for separation and tracking residual waste streams from one or more primary MRF's comprises the steps; separating recyclables from non-recyclables within a residual waste stream; separating the recyclables by one or more parameters, comprising weight, size, density, composition and/or functionality, such that the separated recyclables have a uniform material type of at least 90%; separating the non-recyclables by one or more parameters, comprising weight, size, density, composition and/or functionality, such that at least a portion of the separated non-recyclables have a uniform material type of at least 90%; identifying one or more responsible entities associated with one or more material types of the separated non-recyclables; and aggregating the quantity, material type and responsible entity data such that the data can be communicated to the responsible entity for purposes of reducing the non-recyclable quantity. For purposes herein a “uniform material type and a “predetermined composition” are meant to be the same; they both describe a composition of residual waste that has commercial value either for recycling or for waste-to-energy conversion.

In some embodiments a first fraction of material of predetermined composition derived by processing a residual stream from a primary MRF wherein the residual stream is processed through at least one shaker screen comprising openings greater than 2±1.0 inches in a lateral dimension wherein a second fraction with a dimension less than 2±1.0 inches is removed and the processed residual stream is processed through at least one air separation module operating such that a third fraction comprising material with a apparent density less than 0.1 and a lateral dimension greater than the screen openings is transported up and away from the processed residual stream using at least one negative pressure air separation wherein the processed residual stream is processed through at least one optical sorting system wherein a fourth fraction is removed such that the composition of the first fraction, after removal of the second, third and fourth fractions, is between about 90% and 98% by weight chosen from a group consisting of plastics with #'s from 1 through 7, ferrous metal, non-ferrous metal, cardboard and paper, mixed waste paper, glass, aluminum, PET, HDPE and tin. Optionally, the first fraction consists of a composition greater than about 95% by weight consisting of one or more plastics whose number is from 1 to 7; optionally, plastic #3, PVC, is removed from the first fraction. In some embodiments the fifth fraction of material of predetermined composition derived by processing the second fraction wherein the second fraction is processed through at least one air separation module operating such that a sixth fraction comprising material with a apparent density less than 0.1 and a lateral dimension less than the screen openings is transported up and away from the processed second fraction using at least one negative pressure air separation such that the composition of the fifth fraction after removal of the sixth fraction is between about 90% and 98% by weight of plastics with #'s from 1 through 7, ferrous metal, non-ferrous metal, cardboard and paper, mixed waste paper, glass, aluminum, PET bottles, HDPE bottles and tin. Optionally the fifth fraction consists of a composition greater than about 95% by weight consisting of one or more plastics whose number is from 1 to 7; optionally, plastic #3, PVC, is removed from the fifth fraction.

In some embodiments a first fraction of material of predetermined composition is derived by processing a residual stream from a primary MRF wherein the residual stream is processed through at least one shaker screen comprising openings less than 2±1.0 inches in a lateral dimension wherein a second fraction with a dimension less than 2±1.0 inches is removed and the processed residual stream is processed through at least one air separation module operating such that a third fraction comprising material with an apparent density less than 0.1 and a lateral dimension greater than the screen openings is transported up and away from the first fraction using at least one negative pressure air separation such that the composition of the first stream after removal of the first and second fractions is between about 90% and 98% by weight of plastics with #'s from 1 through 7, ferrous metal, non-ferrous metal, cardboard and paper, mixed waste paper, glass, aluminum, PET, HDPE and tin. Optionally, the first fraction consists of a composition greater than about 95% by weight consisting of one or more plastics whose number is from 1 to 7.

In some embodiments a method for separation and tracking residual waste streams from one or more primary MRF's comprises the steps; separating recyclables from non-recyclables within a residual waste stream; separating the recyclables by one or more parameters, comprising weight, size, density, composition and/or functionality, such that the separated recyclables have a uniform material type of at least 90%; separating the non-recyclables by one or more parameters, comprising weight, size, density, composition and/or functionality, such that at least a portion of the separated non-recyclables have a uniform material type of at least 90%; identifying one or more responsible entities associated with one or more material types of the separated non-recyclables; and aggregating the quantity, material type and responsible entity data such that the data can be communicated to the responsible entity for purposes of reducing the non-recyclable quantity.

I claim:

1. A secondary separation and tracking system for processing residual waste streams from one or more primary MRF's comprising;
a means for separating recyclables from non-recyclables within a residual waste stream;
a means for separating the recyclables by one or more parameters such that the separated recyclables have commercial value;
a means for separating the non-recyclables by one or more parameters such that at least a portion of the separated non-recyclables have commercial value;
a means for identifying one or more responsible entities associated with one or more material types of the separated non-recyclables; and
a means for aggregating the quantity, material type and responsible entity data such that the data can be communicated to the responsible entity for purposes of reducing the non-recyclable quantity.

2. A first fraction of material of predetermined composition derived by processing a residual stream from a primary MRF wherein the residual stream is processed through at least one shaker screen comprising openings greater than 2±1.0 inches in a lateral dimension wherein a second fraction with a dimension less than 2±1.0 inches is removed and the processed residual stream is processed through at least one air separation module operating such that a third fraction comprising material with a apparent density less than 0.1 and a lateral dimension greater than the screen openings is transported up and away from the processed residual stream using at least one negative pressure air separation wherein the processed residual stream is processed through at least one optical sorting system wherein a fourth fraction is removed such that the composition of the first fraction, after removal of the second, third and fourth fractions, is between about 90% and 98% by weight chosen from a group consisting of plastics with #'s from 1 through 7, ferrous metal, non-ferrous metal, cardboard and paper, mixed waste paper, glass, aluminum, PET, HDPE and tin.

3. The first fraction of claim 1 wherein the composition is greater than about 95% by weight consisting of one or more plastics whose number is from 1 to 7.

4. A fifth fraction of material of predetermined composition derived by processing the second fraction from claim 2 wherein the second fraction is processed through at least one air separation module operating such that a sixth fraction comprising material with a apparent density less than 0.1 and a lateral dimension less than the screen openings is transported up and away from the processed second fraction using at least one negative pressure air separation such that the composition of the fifth fraction after removal of the sixth fraction is between about 90% and 98% by weight of plastics with #'s from 1 through 7, ferrous metal, non-ferrous metal, cardboard and paper, mixed waste paper, glass, aluminum, PET bottles, HDPE bottles and tin.

5. The fifth fraction of claim 5 wherein the composition is greater than about 95% by weight consisting of one or more plastics whose number is from 1 to 7.

6. A first fraction of material of predetermined composition derived by processing a residual stream from a primary MRF wherein the residual stream is processed through at least one shaker screen comprising openings less than 2±1.0 inches in a lateral dimension wherein a second fraction with a dimension less than 2±1.0 inches is removed and the processed residual stream is processed through at least one air separation module operating such that a third fraction comprising material with an apparent density less than 0.1 and a lateral dimension greater than the screen openings is transported up and away from the first fraction using at least one negative pressure air separation such that the composition of the first stream after removal of the first and second fractions is between about 90% and 98% by weight of plastics with #'s from 1 through 7, ferrous metal, non-ferrous metal, cardboard and paper, mixed waste paper, glass, aluminum, PET, HDPE and tin.

7. The first fraction of claim 6 wherein the composition is greater than about 95% by weight consisting of one or more plastics whose number is from 1 to 7.

8. A method for separation and tracking residual waste streams from one or more primary MRF's comprising the steps;
separating recyclables from non-recyclables within a residual waste stream;
separating the recyclables by one or more parameters, comprising weight, size, density, composition and/or functionality, such that the separated recyclables have a uniform material type of at least 90%;
separating the non-recyclables by one or more parameters, comprising weight, size, density, composition and/or functionality, such that at least a portion of the separated non-recyclables have a uniform material type of at least 90%;
identifying one or more responsible entities associated with one or more material types of the separated non-recyclables; and
aggregating the quantity, material type and responsible entity data such that the data can be communicated to the responsible entity for purposes of reducing the non-recyclable quantity.
